(19) United States
(12) Patent Application Publication
(10) Pub. No.: US 2010/0006071 A1
(43) Pub. Date: Jan. 14, 2010

(54) Pump Unit

(76) Inventors: Walter Froehlich, Frankfurt am Main (DE); Günter Rauchhaus, Raunheim (DE); Thomas Sippel, Fulda (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/527,236

(22) PCT Filed: Jan. 21, 2008
(86) PCT No.: PCT/EP08/50641

§ 371 Date: Sep. 4, 2009

(30) Foreign Application Priority Data
Feb. 14, 2007 (DE) 10 2007 007 912.7

(51) Int. Cl. F02M 37/10; F02M 37/22

(52) U.S. Cl. 123/497; 417/410.1

(57) ABSTRACT

A pump unit for pumping fuel from a fuel reservoir to an internal combustion engine of a motor vehicle, including a fuel pump disposed in a swirl pot and has a housing made of metal, and a fuel filter, which is disposed downstream of the fuel pump. The housing of the fuel filter is connected to the housing of the fuel pump in an electrically conductive manner.

### PRIORITY CLAIM

This is a U.S. national stage of application No. PCT/EP2008/050641, filed on Jan. 21, 2008, which claims Priority to the German Application No.: 10 2007007 912.7, filed: Feb. 14, 2007, the contents of both being incorporated herein by reference.

### BACKGROUND OF THE INVENTION

1. Field of the Invention

The subject matter of the invention is a pump unit for pumping fuel from a fuel container to an internal combustion engine of a motor vehicle, having a fuel pump which is arranged in a splash pot and has a housing composed of metal, and a fuel filter arranged downstream of the fuel pump.

2. Prior Art

Pump units of this general type are known. In addition, it is known to arrange the fuel filter splash pot. On account of defined safety regulations, components which come into contact with flowing liquids have to be secured against electrostatic charges. As a result, the expenditure increases for the production of the pump unit.

### SUMMARY OF THE INVENTION

The present invention is based on providing a pump unit with low production expenditure.

According to one embodiment of the invention, the object is achieved by the housing of the fuel filter being connected to the housing of the fuel pump in an electrically conductive manner.

As a result of the electrically conductive connection of the two housings, electrostatic charges of the fuel filter are guided in a particularly simple way to the fuel pump, which is grounded via its power supply. Additional safety apparatuses for discharging electrostatic charges can be dispensed with.

Electrostatic charges can be discharged in a simple manner by way of a filter housing made from metal. According to one advantageous refinement, a metal housing is dispensed with if the housing of the fuel filter is composed of an electrically conductive plastic. In comparison with a metal housing, a plastic housing has the advantage that it can be produced by injection molding, which results in a substantially larger number of possible designs. As a result, a filter housing of this type can be adapted to a very wide variety of use conditions.

The electrical conductivity of the housing of the fuel filter is achieved in a simple way by admixtures of metal particles or carbon in the form of carbon black or nanotubes.

The fuel pump is generally arranged in the splash pot via a pump holder. Accordingly, the latter has to be configured such that an electrically conductive connection from the filter housing to the pump housing is possible. According to one advantageous refinement, the pump holder is likewise composed of an electrically conductive plastic, which pump holder is integrally formed in one piece on the filter housing. A component of this type can be produced simply by injection molding.

To adapt the arrangement of the fuel pump and the fuel filter in the splash pot in a variable manner to different use conditions, the housing of the fuel filter is connected to the holder for the fuel pump via an integrally formed web. The possible variations result from the arrangement of the web with regard to the circumference and the height of the filter housing, and with regard to the width of the web which defines the spacing of the pump holder from the filter housing. The expenditure for producing a component of this type remains virtually identical as a result of this refinement.

In another refinement, the connection of the filter housing to the housing of the fuel pump is produced by the housing of the fuel filter being connected to the fuel pump via the inlet stub. Since the fuel which is pumped by the fuel pump has to be fed to the fuel filter anyway, the inlet stub is designed in such a way that it can be connected to the outlet stub of the fuel pump, preferably by being plugged on. Here, the outlet stub in the connection piece of the fuel pump likewise has to be composed of an electrically conductive material.

### BRIEF DESCRIPTION OF THE DRAWING

The invention will be explained in greater detail using two exemplary embodiments. In the drawing:

FIG. 1 is a diagrammatic illustration of the pump unit in a fuel container;

FIG. 2 is a plan view of the filter housing and the pump holder; and

FIG. 3 is a section through the filter housing and the pump holder according to FIG. 2.

### DETAILED DESCRIPTION OF THE DRAWINGS

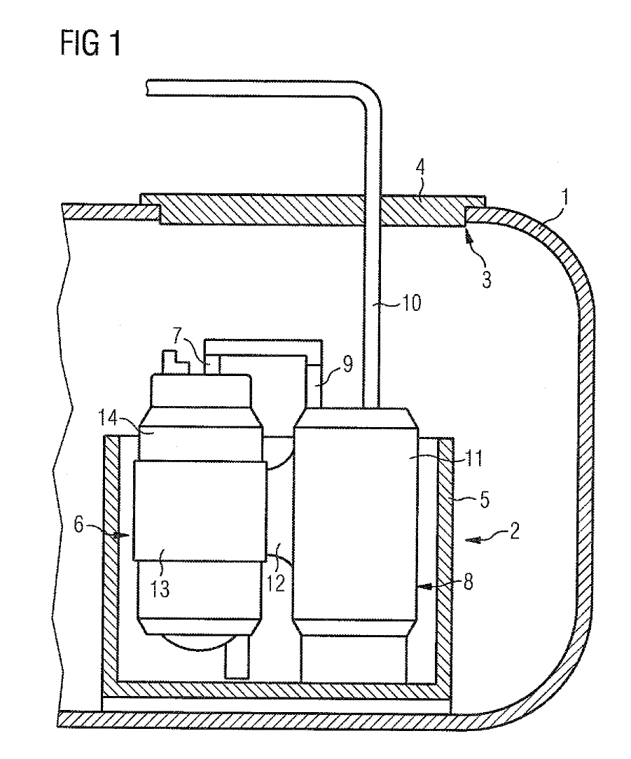

FIG. 1 is a fuel container 1 of a motor vehicle (not shown in further detail) having a pump unit 2 which is inserted through an opening 3 in the fuel container 1. After assembly has been carried out, the opening 3 is closed with a Range 4. The pump unit 2 comprises a splash pot 5 which is prestressed against the bottom of the fuel container 1. A fuel pump 6 which sucks fuel out of the splash pot 5 and pumps it via an outlet stub 7 is arranged in the splash pot 5. Furthermore, a fuel filter 8 is arranged in the splash pot 5, which fuel filter 8 is arranged downstream of the fuel pump 6 as viewed fluidically, with the result that the fuel which is pumped by the fuel pump 6 passes via an inlet stub 9 into the fuel filter 8. The filtered fuel is subsequently fed via an inflow line 10 through the flange 4 to an internal combustion engine (not shown) of the motor vehicle. Housing 11 of the fuel filter 8 has an integrally injection molded web 12 that merges into a pump holder 13. The fuel pump 6 is mounted in the region of its housing 14 in the pump holder 13. In a preferred embodiment, housing 14 of the fuel pump 6 is metallic. The filter housing 11 is composed of polyoxymethylene, which is electrically conductive as a result of the admixture of carbon black. Electrostatic charges produced in the fuel filter 8 are transmitted via the filter housing 11, the web 14 and the pump holder 13 to the housing 14 of the fuel pump 6, from where they are discharged safely via the power supply (not shown).

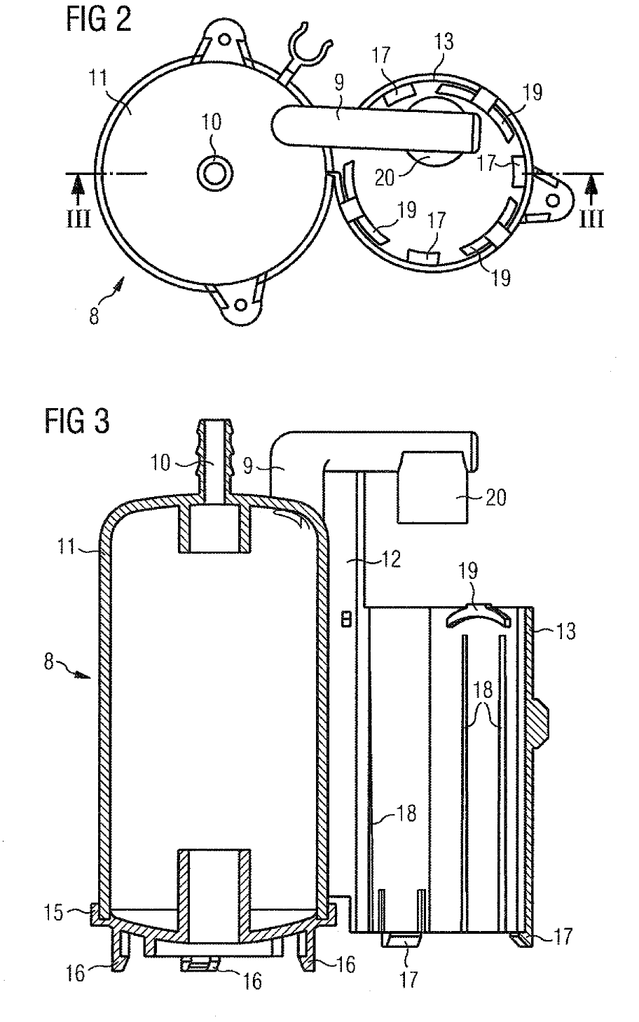

FIG. 2 is a top view of the filter housing 11 with the outlet stub 10 and the inlet stub 9. The fuel filter is not shown in this view. The pump holder 13 is integrally formed on the filter housing 11 by means of injection molding, with the result that both components form one unit.

The section in FIG. 3 shows the filter housing 11, a lower end of which is closed with a cover 15. The fuel filter 8 is fastened in the splash pot via latching hooks 16, which are integrally formed on the cover 15. The pump holder 13 likewise has latching hooks 17, via which the pump holder is connected to the splash pot. Longitudinally extending webs 18 and holding springs 19 for receiving and mounting the fuel pump 6 are preferably formed on the inner wall of the pump holder 13. Furthermore, the filter housing 11 has an inlet stub 9 of extended configuration with a receptacle 20 which is designed such that it can be plugged onto the outlet stub 7 of the fuel pump 6.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-6. (canceled)

7. A pump unit configured to pump fuel from a fuel container to an internal combustion engine, the pump unit comprising:
a fuel pump having a metal housing; and
a fuel filter arranged downstream of the fuel pump, the fuel filter comprising a filter housing,
wherein the filter housing is electrically coupled to the metal housing of the fuel pump.

8. The pump unit as claimed in claim 7, wherein the filter housing comprises an electrically conductive plastic.

9. The pump unit according to claim 8, wherein the filter housing comprises admixtures of carbon in the form of one or more of carbon black and nanotubes.

10. The pump unit according to claim 9, wherein the filter housing further comprises an integrally formed fuel pump holder configured for holding the fuel pump.

11. The pump unit according to claim 10, wherein the filter housing is connected to the integrally formed fuel pump holder via an integrally formed web.

12. The pump unit according to claim 10, wherein the filter housing comprises a connection piece, the connection piece configured for fluidic connection to the fuel pump.

13. The pump unit according to claim 12, wherein the connection piece is configured for fluidic connection to an outlet stub of the fuel pump.

14. The pump unit according to claim 7, wherein the filter housing comprises admixtures of metal particles.

15. The pump unit according to claim 10, wherein pump unit is configured to be arranged in a splash pot.

16. The pump unit according to claim 15, wherein the fuel pump holder further comprises at least one latching hook configured to connect the fuel pump holder to the splash pot.

17. The pump unit according to claim 16, wherein the fuel pump holder further comprises at least one holding spring and at least one longitudinally extending web configured to receive and mount the fuel pump.
